(19) United States
(12) Patent Application Publication
(10) Pub. No.: US 2003/0145025 A1
(43) Pub. Date: Jul. 31, 2003

(54) Method of designing families of boost and cut filters, including treble and bass controls and graphic equalizers

(76) Inventors: Rustin W. Allred, Plano, TX (US); David Dean Ratcliff, Plano, TX (US)

Correspondence Address: Dan Swayze, Texas Instruments Incorporated, P. O. Box 655474, M/S 3999, Dallas, TX, 75265, US

(21) Appl. No.: 10/253,676

(22) Filed: Sep. 24, 2002

Related U.S. Application Data
(60) Provisional application No. 60/353,924, filed on Jan. 31, 2002.

(51) Int. Cl. G06F 17/10

(52) U.S. Cl. 708/320

(57) ABSTRACT

A simplified design for a family of bass, treble and graphic equalizer filters (20). The filter design allows on-the-fly implementation of these simplified filter types, even in audio systems without extensive computation resources. The methodology includes designing a nominal filter, and decomposing this nominal filter into a simplified transfer function such that the family of treble boost, cut, and equalizer filters can be realized with moderate computational resources.

### PRIORITY CLAIM

This application claims priority of US Provisional Patent, Serial No. 60/353,924, filed Jan. 31, 2002 entitled “Method of Designing Families of boost and Cut Filters, including Treble and Bass Controls and Graphic Equalizers”, the teaching of which are incorporated herein by reference.

### CROSS REFERENCE TO RELATED APPLICATIONS

Cross reference is related to co-pending commonly assigned U.S. application Ser. No. 09/408,095, filed Sep. 27, 1999, entitled DIGITAL TONE CONTROL WITH LINEAR STEP COEFFICIENTS; Ser. No. 09/401,422, filed Sep. 22, 1999, entitled DIGITAL GRAPHIC EQUALIZER CONTROL SYSTEM AND METHOD; and Ser. No. 10/012,657, filed Oct. 30, 2001, entitled EFFICIENT REAL-TIME COMPUTATION OF FIR FILTER COEFFICIENTS, the teaching of which are incorporated herein by reference.

### FIELD OF THE INVENTION

The present invention relates to treble and bass controls and graphic equalizers and methods of implementing or designing them, and, more particularly, to techniques for designing and implementing one or a family of digital treble/bass controls and graphic equalizers that may be implemented on silicon or otherwise and that use as a starting point a second order infinite impulse response filter (“IIR filter”).

### BACKGROUND OF THE INVENTION

Various methods are known for designing boost and cut filters for use in analog and digital audio systems. Previous known methods are rather arduous when used to design a single filter and are especially so when used to design a family of filters. Designing in accordance with the prior art may be expedited and simplified by a designer using a personal computer and other appropriate tools. Nevertheless, this protocol would stress and overtax many processors and, in some applications, would involve an unacceptable expense. Moreover, the foregoing methods do not lend themselves to use by a processor for instantaneously, or nearly so, designing and implementing a filter in an audio system. For example, if an audio system is expected to configure and implement a filter in nearly instantaneous response to a user turning a knob or pushing a button on a console, it must do so quickly and in some proportion to the amount of knob turning or in response to a value or function selected by the pushed button. Current processors used in audio systems are not capable of accurately performing the mathematical calculations and then precisely deriving and implementing the calculated filter according to these prior art methods. Again, the prior methods involve calculations that can be only relatively slowly performed by a reasonable number of presently available processors. In some cases, large numbers of processors may be able to perform the required calculations, design and implementation in sufficiently short times, but the expense involved in multiple-processor configurations would usually be too costly.

The method of the present invention is intended to ameliorate the shortcomings of the methods of the prior art.

### SUMMARY OF THE INVENTION

The present invention derives technical advantages as simplified designs of bass, treble and graphic equalization filters. This present invention allows on-the-fly implementation of these simplified filter types, even in systems without extensive computation resources.

### BRIEF DESCRIPTION OF THE DRAWING

FIG. 1 is a schematic representation of a second-order IIR filter;

FIG. 2 is a schematic representation of filter circuit which permits the decomposition of the filter of FIG. 1 for purposes of designing a family of filters according to the present invention;

FIG. 3 is a graphical representation of the transfer function of a treble boost filter designed according to the prior art;

FIG. 4 is a graphical representation of the transfer function of a nominal filter present in the circuit of FIG. 2 when the latter represents the decomposed version of the filter in FIG. 1 as both are used in the method of the present invention to design a family of filters which includes the filter of FIG. 3;

FIG. 5 is a graphical representation of a family of treble boost filters, including the filter of FIG. 3, designed in accordance with the principles of the present invention;

FIG. 6 is a graphical representation of the transfer function of an equalization cut filter designed according to the prior art;

FIG. 7 is a graphical representation of a family of equalization cut filters, including the filter of FIG. 6, designed in accordance with the principles of the present invention;

FIG. 8 is a graphical representation of a bass boost and a bass cut filter according to the present invention; and

FIG. 9 is a schematic representation of a filter structure that does not require coefficient normalization.

### DETAILED DESCRIPTION—SIGNAL BOOST

Initially, there is described a methodology for designing one filter or a family of filters for achieving treble, bass and graphic equalization signal boosts, i.e., signal gains greater than 0 dB.

In FIG. 1, there is a schematic representation of a second order Infinite Impulse Response filter 10 (“IIR filter”). The coefficients of the filter 10 are, as is conventional, designated B₀-->b₀, b₁, b₂, and A₀-->1 (i.e., a₀=1), a₁, and a₂. These coefficients determine the transfer function Hₒ(z) of the filter 10, where H₀(z) is the result of dividing the output Y₀(z) of the filter 10 by its input X₀(z), or, [Y₀(z)/X₀(z)]. In the signal boost situation initially under consideration, the filter 10 has an active region gain, designated gₒ, which constitutes a shelf gain if the filter 10 is used as a shelf filter or a peak gain if the filter 10 is used as a graphic equalizer having a bell-shaped characteristic.

The input signal to the filter 10 is xₒ(n) and the output signal is yₒ(n). As noted, the transfer function Hₒ(z) of the filter 10 is given by is Yₒ(z)/Xₒ(z)=Hₒ(z). In preferred embodiments of the invention, the input signal xₒ(n) is a series of discrete values, such as those constituting a digital audio signal, but may be a series of other discrete values, including a series of DC inputs.

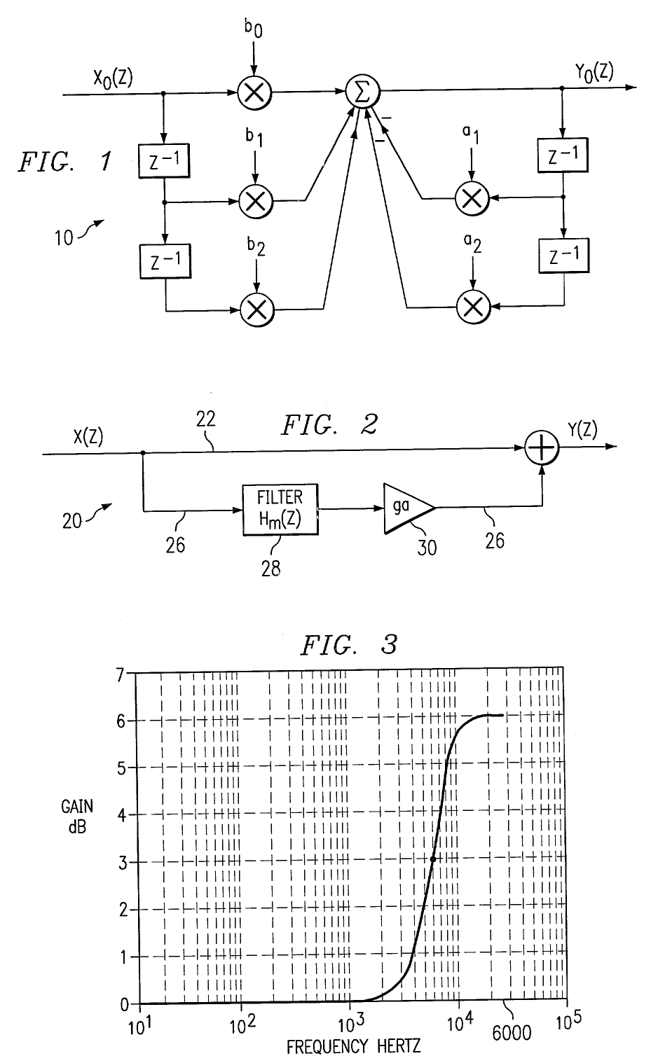

In accordance with the present invention, the filter 10 of FIG. 1 is analytically decomposed so as to take the form of circuitry 20, as schematically depicted in FIG. 2. Such decomposition permits mathematical and other manipulations to be effected to achieve the goal of the present invention, namely a simple and expedient method for designing one, several or a family of boost and cut filters and graphic equalizers.

The circuitry 20 includes a first path 22 interconnecting an input X(z) and a summing device or signal combiner 24, the output of which is the output Y(z) of the circuit 20. A second path 26 between the summing device 24 and the input X(z) includes a filter 28, having a transfer function Hₘ(z). The output of the filter 28 is subjected to gain gₐ, as shown at 30. The input X(z) traverses the path 22 unchanged and is input to the summing device 24. The input signal X(z) is affected by the filter 28 and the gain 30 so that the input on the path 26 to the summing device 24 is gₐ[Hₘ(z)] [X(z)]. Thus, the output Y(z) is given by:

Y(z)=X(z)+gₐ[Hₘ(z)][X(z)]. <1>

Dividing by X(z), the end-to-end transfer function H(z) for the circuit 20 is, accordingly;

H(z)=Y(z)/X(z)=gₐ[Hₘ(z)]+1. <2>

The following interesting conclusions have been drawn by the present inventors: If, in transfer function equation <2> for the circuit in FIG. 2, the value of gₐ is assigned the value of 1, i.e.;

gₐ=1, <3>

and the value of Hₘ(z) is assigned the value of [Hₒ(z)−1], i.e.;

Hₘ(z)=Hₒ(z)−1, <4>

where Hₒ(z) is the transfer function of the filter 10 in FIG. 1, the end-to-end transfer function H(z) of the circuit 20 in FIG. 2 equals the transfer function Hₒ(z) of the filter 10 in FIG. 1. Specifically, with these substitutions;

H(z)=(1)[Hₒ(z)−1]+1=Hₒ(z). <5>

Stated differently, when gₐ and Hₘ(z) assume the respective values in equations <3> and <4>, the transfer functions of FIGS. 1 and 2 are the same, and the filter 10 and the circuit 20 are, as a consequence, functional equivalents. The foregoing discovery is the key that opens the door to the present invention.

As previously described, equation <4> involves setting Hₘ(z) equal to Hₒ(z)−1. In FIG. 1, by convention;

b₀+b₁z⁻¹+b₂z⁻²=Bₒ(z), <6>

1+a₁z⁻¹+a₂z⁻²=Aₒ(z), and <7>

Hₒ(z)=Bₒ(z)/Aₒ(z). <8>

Combining equations <4> and <8> yields:

Hₘ(z)=[Bₒ(z)/Aₒ(z)]−1 <9>

=[Bₒ(z)−Aₒ(z)]/Aₒ(z) <10>,

by expanding <9>

or,

=Bₘ(z)/Aₘ(z). <10a>

Hₒ(z), the transfer function of the filter 10 in FIG. 1, includes some inherent gain, previously defined as the active region gain gₒ. From equation <4>, Hₘ(z) was intentionally selected to equal the quantity [Hₒ(z)−1]. Accordingly, the active region gain gₐ of Hₘ(z), the transfer function of the filter 28, is the quantity [gₒ−1]. Further, H(z), the end-to-end transfer function of the circuit 20 in FIG. 2 is given by:

H(z)=gₐ[Hₘ(z)]+1. <11>

Thus, from the quantity [gₒ−1] and equation <11>, it follows that the end-to-end active region gain, designated g_{d}, of the circuit 20 having the end-to-end transfer function H(z) is given by the expression:

g_{d}=gₐ(gₒ−1)+1, or <12>

gₐ=(g_{d}−1)/(gₒ−1). <13>

The gain derivation is further detailed in section Gain Derivations below.

From equation <11>, the transfer function H(z) of the circuit 20 in FIG. 2 is given by

H(z)=1+gₐ[Hₘ(z)] <14>

=1+gₐ[B₀(z)−A₀(z)]/A₀(z) <15>,

from <10> and <1>

$$\begin{matrix}H ( z ) = 1 + {g}_{a} [ {H}_{m} ( z ) ] & ⟨ 14 ⟩ \\ = 1 + {g}_{a} [ {B}_{0} ( z ) - {A}_{0} ( z ) ] / {A}_{0} ( z ) , & ⟨ 15 ⟩ \\ from ⟨ 10 ⟩ and ⟨ 1 ⟩ & \\ expansion of ⟨ 15 ⟩ , & \\ = \frac{{A}_{0} ( z ) + {g}_{a} [ {B}_{0} ( z ) - {A}_{0} ( z ) ]}{{A}_{0} ( z )} . & ⟨ 16 ⟩\end{matrix}$$

expansion of <15>

Recalling that g_{d} is the desired end-to-end gain of the circuit 20—and it, accordingly, assumes a desired, or known, value—and that the value gₒ of the filter 10 is known, the value of gₐ in equation <16> may be calculated from equation <13>.

As a result of the foregoing, and according to the principles of the present invention, equation <15> contains all of the information that is necessary and sufficient to manipulate the coefficients A₀ and B₀ in order to achieve a desired filter function. Specifically, the filter 10 having a selected gain g₀ and a desired transfer function H(z) is designed. If the filter 10 is a boost filter, it can be a treble shelf, a bass shelf or a graphic equalizer. In any event, the filter 10 may initially be designed as one member of a family of filters to be implemented. Next, the filter 10 is decomposed, as described above, and a new end-to-end gain g_{d} is applied, and its value is used to calculate the value of the gain gₐ. Equation <16> is then utilized to recompose the filter 10 as an entire family of filters as to which the coefficients of the may be determined according to equation <16>.

Thus, with g_{d}, gₒ and H(z) known, and with gₐ calculable from g_{d} and gₒ, the coefficients A₀ and B₀ are determined according to equation <16>. Advantageously, from the foregoing it follows that a boost filter of any gain may be implemented merely by changing the value of g_{d}, from which gₐ may simply and expeditiously be calculated. In the prior art, the foregoing is achievable only by the time-consuming and arduous procedure of changing and manipulating all five coefficients b₀, b₁, b₂, a₁ and a₂ for each change in gain.

### EXAMPLE 1

Assume it is desired to design a family of treble shelf boost filters. An excellent technique for designing the initial member of a 2^{nd} order IIR shelf filter family is set forth in sections 2.1 and 2.2 of the article “The Manifold Joys of Conformal Mapping: Applications to Digital Filtering in the Studio,” by James A. Moorer in The Journal of the Audio Engineering Society, Volume, 31, Number 11, November, 1983. Utilizing Moorer's techniques, a treble shelf filter with a gain of 2 (6 dB)—20log₁₀ 2=6 dB—and a corner frequency of 6 kHz, which is 3 dB less than the shelf gain for a 48 kHz sample rate, has the following coefficients:

B₀=b₀, b₁, b₂=1.66445378394369, −1.81240001030095, 0.64842666949845 and

A₀=1, a₁, a₂=1.0, −0.78107989436518, 0.28156033750637.

The transfer function, Ho, of this filter is plotted in FIG. 3.

Decomposing the filter of FIG. 3 according to Equation <10> of the present invention results in:

Bₘ=B₀−A₀=0.66445378394369, −1.03132011593577, 0.36686633199208 and

Aₘ=A₀

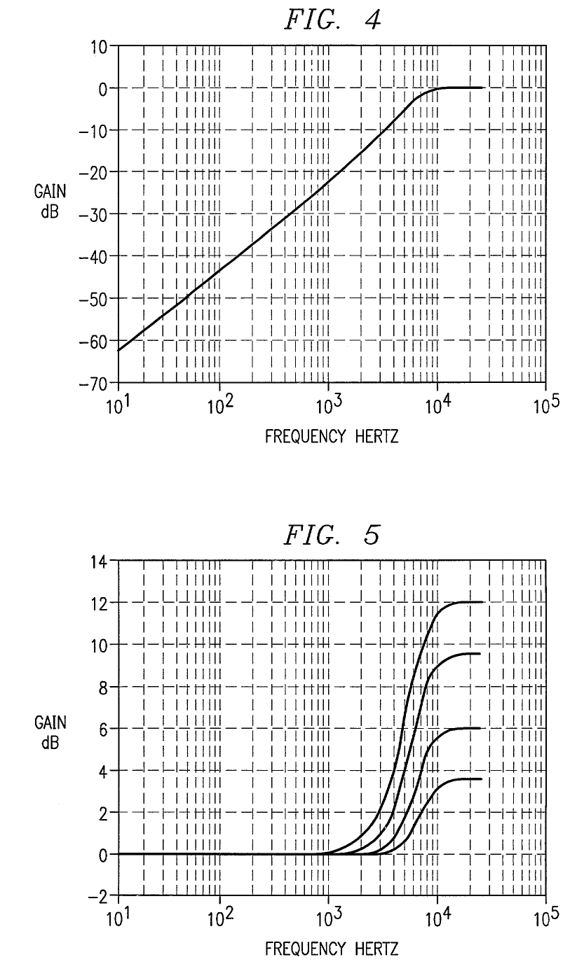

The transfer function, H₀, of the filter of FIG. 3 is plotted in FIG. 4.

Now assume that it is desired to create a family of filters, including the filter of FIGS. 3 and 4, with the individual filters of the family having gains of 4 (12 dB), 3 (9.5 dB), 2 (6 dB, the original filter) and 1.5 (3.5 dB). According to the present invention, equation <13> is used to compute the values of gₐ for each filter, as, respectively, 3, 2, 1, and 0.5, noting that that g₀ is 2.

Equation <16> shows that the numerator coefficients for each of the four filters are as follows, while the denominator coefficients remain unchanged:

b₀, b₁, b₂=2.99336135183108, −3.87504024217249, 1.38215933348261 (gain=4)

=2.32890756788738, −2.84372012623672, 1.01529300149053 (gain=3)

=1.66445378394369, −1.81240001030095, 0.64842666949845 (gain=2)

=1.33222689197185, −1.29673995233306, 0.46499350350241 (gain=1.5)

It should be noted that these coefficients do not have to be computed specifically if the implementation uses the structure of FIG. 2. These four filters are plotted in FIG. 5, whereat, it will be noted that the filters all have the desired gains and that the 6 dB filter (gain=2) is equivalent to the filters of FIGS. 1 and 2.

Detailed Description—Signal Cut

The foregoing approach also advantageously serves as the basis for developing families of cut filters, that is, filters having a bandpass gain less than 0 dB. Following the development of the boost filter implementation technique, the inventors intuitively elaborated an equation based on equation <16> in which the numerator and denominator were reversed, B₀ replaced all A₀ terms, and A₀ replaced all B₀ terms. This intuitive elaboration was prompted by the analysis of the boost case and observation. Simply stated, for the cut filter case, the counterpart of equation <16> for the boost filter case is

$$H ( z ) = \frac{{B}_{0} ( z )}{{B}_{0} ( z ) + {g}_{a} [ {A}_{0} ( z ) - {B}_{0} ( z ) ]} . \qquad ⟨ 17 ⟩$$

When comparing equations <16>—for the boost case—and <17>—for the cut case—it will be observed that each equation is the inverse of the other with the coefficients A₀ and B₀ in one equation being substituted for B₀ and A₀, respectively, in the other equation. Equations <16> and <17> lie at the heart of the methodology for evolving families of boost and cut filters.

In an attempt to analyze and rationalize filter design, the inventors hereof underwent the painstaking and arduous process of designing each filter of each family of filters independently by the laborious prior art methods and followed by testing of the filters and comparison of adjacent filters in a family.

Analysis of the transfer function Hₒ(z)=Yₒ(z)/Xₒ(z) of each filter indicated that for boost filters the changes in the numerator of the transfer function from filter to filter are far more significant than the relatively small changes in the denominator. Thus, part of the intuitive process leading to the cut filter case was an assumption that the reverse would be true for cut filters. That is, it was assumed that the denominator of the fraction defining the transfer function for a cut filter would change more significantly from filter to filter compared to relatively small changes in the numerator. Furthermore, it was also assumed that the denominator of a cut filter transfer function would change in the same way as the numerator of the boost case. All of the foregoing gave rise to the notion that the same technique used for the transfer function numerator of boost filters could be applied to the denominator of cut filters. In this manner, following the development of the boost filter implementation technique, as described above, the inventors intuitively elaborated equation <17> from equation <16>.

The derivation of the mathematical relationship between gₒ of the filter 10, gₐ 30 of the circuit 20 and the desired gain g_{d} in the cut signal situation, as shown in section Gain Derivations below, yields:

gₐ=[gₒ−gₒg_{d}]/[g_{d}−gₒg_{d}], <18>

which may be simplified to:

[go/gd][gd−1)/(go−1)]=[go/gd][equation <13>]. <18a>

### EXAMPLE 2

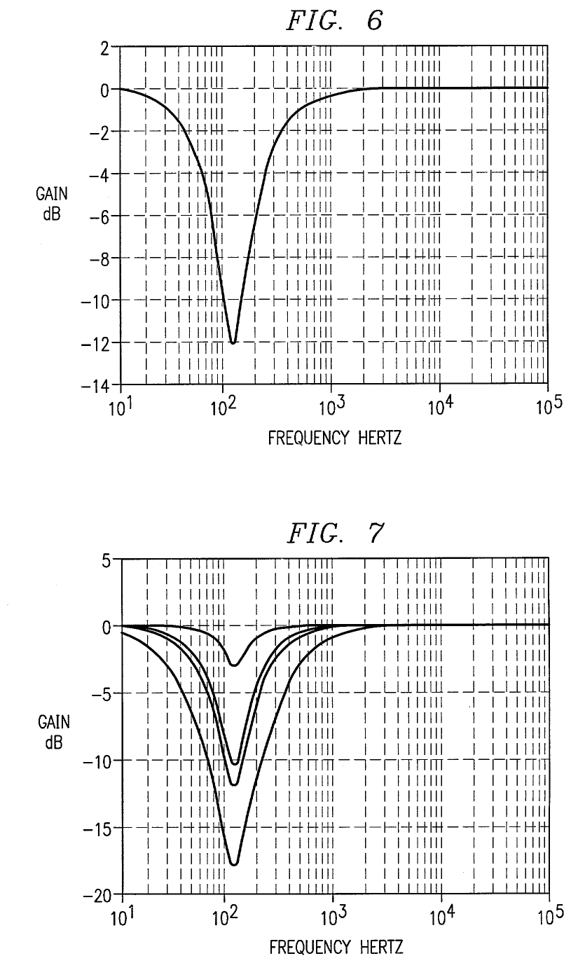

In designing a graphic EQ Cut Filter, one may begin with a filter having an initial gain, g₀, of 0.25, (−12 dB). Assume that an initial filter is designed to have a 125 Hz center frequency and 62.5 Hz bandwidth for a sample rate of 96 kHz, as shown in FIG. 6, according to techniques set forth in “The Equivalence of Various Methods of Computing Biquad Coefficients for Audio Parametric Equalizers,” by Robert Brislow Johnson in the Proceedings of the AES 97^{th} Convention, November, 1994. Following this design technique:

Bo=b1,b2,b3=0.99391386047433, −1.98370390557768, 0.98985643412389

Ao=a1,a2,a3=1.0, −1.98370390557768, 0.98377029459822

The transfer function is plotted in FIG. 5:

In this case the present inventors assumed Equation <17> is based upon the observations discussed above and derived Equation <18> accordingly. It has also been shown by the present inventors that these equations do indeed create cut-region bass, treble, and bell filters that are symmetric with the boost-region filters discussed above.

As noted earlier, having intuited equation <17> and, based thereon, having derived Equation <18> accordingly, the present inventors designed a cut filter pursuant to these two equations. Exhaustive tests of the cut filters so designed have shown that these equations <17> and <18> can indeed advantageously be used to create cut-region bass, treble, and bell filters that are symmetric with the boost-region filters discussed above.

In the instant example, B(z)=B₀(z) and A(z)=B₀(z)+gₐ[A₀(z)−B₀(z)]. If the cut filters to be designed have desired gains of 0.125 (−18 dB), 0.25 (−12 dB, the original cut filter), 0.3 (−10.5 dB) and 0.7 (−3 dB), g_{d} has the following values: 2.3333, 1.0, 0.7778, 0.1429, which, when applied to Equation <17>, leads to the following denominator values:

Ao=a1,a2,a3=1.00811464982957, −1.98370390557768, 0.97565564476864 {gain=0.125)

Ao=a1,a2,a3=1.00000000000000, −1.98370390557768, 0.98377029459822 (gain=0.25)

Ao=a1,a2,a3=0.99864765979740, −1.98370390557768, 0.98512263480082 (gain=0.3)

Ao=a1,a2,a3=0.99478356981255, −1.98370390557768, 0.98898672478567 (gain=0.7)

Renormalizing these filters to the circuit of FIG. 1 prior to implementation results in the following values:

Gain=0.125

B₀=0.98591351751744, −1.96773641362423, 0.98188875074004

A₀=1.00000000000000, −1.96773641362423, 0.96780226825747

Gain=0.25

B₀=B₀

A₀=A₀

Gain=0.3

B₀=0.99525979030079, −1.98639018087733, 0.99119686949920

A₀=1.00000000000000, −1.98639018087733, 0.98645665979999

Gain=0.7

B₀=0.99912573009385, −1.99410602041957, 0.99504702747594

A₀=1.00000000000000, −1.99410602041957, 0.99417275756980

This family of cut filters is plotted in FIG. 7.

Further investigation has shown that an n-dB cut filter is just the inverse of the corresponding n-dB boost filter. This is less than obvious due to the renomalization that must take place prior to implementation, which forces the a₀ coefficient to be 1. For example, using the technique of Moorer, a 12 dB bass cut and a 12 dB bass boost filter are each designed to have a cutoff frequency of 250 Hz at a sampling rate of 48 kHz as shown in FIG. 8. The boost case coefficients are:

B=1.02262174205123 −1.95377675721273 0.93507404990074

A=1.00000000000000 −1.95524639523995 0.95622615392476

and the cut case coefficients are:

B=0.97787868072719 −1.91199376547384 0.93507316987678

A=1.00000000000000 −1.91055663777864 0.91438897829917

Here it is noted that the cut case coefficients can be generated from the boost case coefficients by reversing the numerator and denominator (B, A) and renormalizing so that the a₀ coefficient is equal to 1. The same holds true for deriving the boost case coefficients from the cut case.

The forgoing not only explains why equations <17> and <18> apply, but it gives insight into yet another possible implementation for the cut case: derive the coefficients for the corresponding boost case, switch numerator and denominator (A, B) and renormalize.

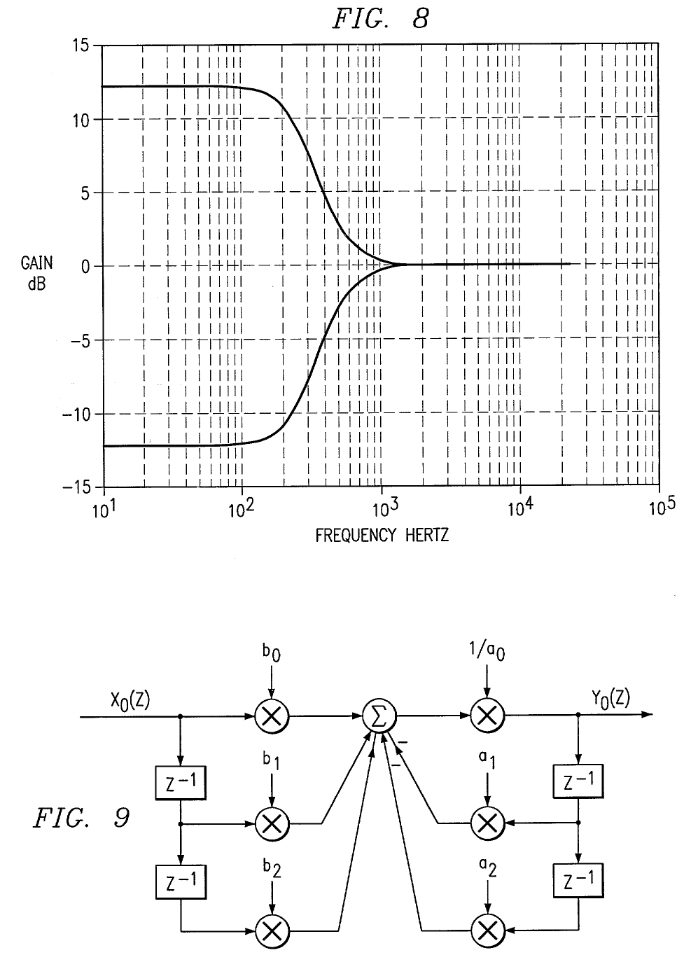

Either implementation requires renormalization of the denominator coefficients for those cases where a₀ is not equal to 1. This can be accomplished by dividing all the other coefficients through by a₀, or it can be accomplished by implementing the filter in a non-standard structure such as shown in FIG. 9. Here, rather than dividing each coefficient individually by a₀, a single division by a₀ (or multiplication by its reciprocal) is performed as part of the filter structure, as can be seen by the following derivation of the transfer function:

$${Y}_{0} ( z ) = \frac{1}{{a}_{0}} \{ {X}_{0} ( z ) [ {b}_{0} + {b}_{1} {z}^{- 1} + {b}_{2} {z}^{- 2} ] - {Y}_{0} ( z ) [ {a}_{1} {z}^{- 1} + {a}_{2} {z}^{- 2} ] \}$$

$${Y}_{0} ( z ) = [ 1 + \frac{{a}_{1}}{{a}_{0}} {z}^{- 1} + \frac{{a}_{2}}{{a}_{0}} {z}^{- 2} ] = {X}_{0} ( z ) [ \frac{{b}_{0}}{{a}_{0}} + \frac{{b}_{1}}{{a}_{0}} {z}^{- 1} + \frac{{b}_{2}}{{a}_{0}} {z}^{- 2} ]$$

$${H}_{0} ( z ) = \frac{{Y}_{0} ( z )}{{X}_{0} ( z )} = \frac{\frac{{b}_{0}}{{a}_{0}} + \frac{{b}_{1}}{{a}_{0}} {z}^{- 1} + \frac{{b}_{2}}{{a}_{0}} {z}^{- 2}}{1 + \frac{{a}_{1}}{{a}_{0}} {z}^{- 1} + \frac{{a}_{2}}{{a}_{0}} {z}^{- 2}}$$

As shown, the normalization of all coefficients is taken care of by the simple insertion of the reciprocal of a₀.

Implementation

I) Implementation Issue 1—Softening

As can be expected from any such endeavor, there are a few challenges associated with the proposed algorithm and implementation scheme. The first of these, softening, is dealt with in this section.

The term softening applies to the process used to disallow instantaneous gain changes from causing audible artifacts such as pops, clicks, or zipper noise. This issue has been dealt with in various ways for graphic equalizers and tone controls such as co-pending commonly assigned patent application Ser. No. 09/408,095, filed Sep. 27, 1999, entitled DIGITAL TONE CONTROL WITH LINEAR STEP COEFFICIENTS and Ser. No. 09/401,422, filed Sep. 22, 1999, entitled DIGITAL GRAPHIC EQUALIZER CONTROL SYSTEM AND METHOD, which are incorporated herein by reference. Perhaps the simplest technique, which is completely adequate for the current application, and was put forward initially in Ser. No. 09/401,422, filed Sep. 22, 1999 entitled DIGITAL GRAPHIC EQUALIZER CONTROL SYSTEM AND METHOD, is to limit gain changes to about 0.05 (not dB, but actual linear gain) per step. This means that the softening can be accomplished simply by the microprocessor. If the user commands a gain change, the microprocessor checks to see if the transition from old gain to new is greater than 0.05. If so, it moves the gain in increments of 0.05, transferring new coefficients to the Audio Processor each time, and allowing some number of samples to process between each coefficient change. The number of samples to be processed between gain changes can vary depending upon the application, but there are two considerations in choosing the value. The first consideration is that the very notion of softening requires that some amount of data pass through the filter between each change of coefficients. This is what solves the first order artifacts, the clicks, pops and zipper noise that can occur when changing coefficients.

But there is an additional consideration regarding the time it takes to move from one gain to the next, especially when that is across a broad gain range. Now a more subtle artifact, such as a swoosh, can occur due to rapidly changing the amount of energy in the signal. Subjective listening tests have indicated that processing approximately 64 samples between coefficient changes gives a good sound and an analog feel to the gain transition when operating in the neighborhood of a 48 kHz sample rate. This number can be modified somewhat to keep the overall transition time fairly constant across sample rates.

Implementation Issue 2—Normalization

Taking notice of Equation (3) it is seen that the a₀ coefficient, which was valued 1 for the original filter, now becomes gₐ+b₀(1−gₐ), which, in general, will not be equal to 1. Since the filter structure assumes an a₀ coefficient of 1, the derived coefficients must be re-normalized before being implemented, or, the filter structure of FIG. 9 can be used, but an inverse must still be formed.

In architectures where division capability is available, the re-normalization is accomplished simply by dividing all coefficients by the new a₀ coefficient. However, if division capability is not available, it is necessary to approximate an inverse in order to re-normalize these coefficients.

In commonly assigned co-pending patent application Ser. No. 10/012,657, filed Oct. 30, 2001, entitled EFFICIENT REAL-TIME COMPUTATION OF FIR FILTER COEFFICIENTS, incorporated herein by reference, a scalable inverse technique uses a 64 element, 20 bit table to accomplish its intended purpose. However, for the current application, the table is expanded to 512 elements of 32 bits each. This provides an inverse approximation good to 5×10⁻⁷ for values in the expected range, which is adequate to allow implementation of the most stressing filters, very low frequency filters for high sample rates (up to 192 kHz). For higher frequency filters or lower sample rates the problem is less stressing so this inverse approximation function allows implementation of most any desired filter.

This approximation technique can be used in architectures without division capabilities.

Gain Derivations

Filter Transfer Function:

$$\begin{matrix}{y}_{0} ( n ) = {b}_{0} {x}_{0} ( n ) + {b}_{1} {x}_{0} ( n - 1 ) + {b}_{2} {x}_{0} ( n - 2 ) - \\ {a}_{1} {y}_{0} ( n - 1 ) - {a}_{2} {y}_{0} ( n - 2 )\end{matrix}$$

Z Transform:

$$\begin{matrix}{Y}_{0} ( z ) = {b}_{0} {X}_{0} ( z ) + {b}_{1} {z}^{- 1} {X}_{0} ( z ) + {b}_{2} {Z}^{- 2} {X}_{0} ( z ) - \\ {a}_{1} {z}^{- 1} {Y}_{0} ( z ) - {a}_{2} {z}^{- 2} {Y}_{0} ( z )\end{matrix}$$

Y₀(z) [1+a₁z⁻¹+a₂z⁻²]=X₀(z)=X₀(z)[b₀+b₁z⁻¹+b₂z⁻²]

$$\frac{{Y}_{0} ( z )}{{X}_{0} ( z )} = {H}_{0} ( z ) = \frac{{b}_{0} + {b}_{1} {z}^{- 1} + {b}_{2} {z}^{- 2}}{1 + {a}_{1} {z}^{- 1} + {a}_{2} {z}^{- 2}}$$

$${H}_{0} ( z ) = \frac{{B}_{0} ( z )}{{A}_{0} ( z )}$$

where:

B₀=b₀+b₁z⁻¹+b₂z⁻²

A₀=1+a₁z⁻¹+a₂z⁻²

Derivation of Boost Case Gain gₐ

H₀(z) has some inherent (designed) gain g₀. This is linear gain:

G₀(dB)=20log₁₀(g₀)

Hₘ(z)=H₀(z)−1

So, active region gain of Hₘ(z)=g₀−1 (Follows from Hₘ(z)=H₀(z)−1)

Now, if the overall transfer function of FIG. 2 is H_{E}(z), Y_{E}(z)=X_{E}(z)+gₐHm(z)X(z), H_{E}(z)=Y_{E}(z)/X_{E}(z)=H_{E}(z)=gₐHₘ(z)+1

If g_{d} is defined to be the desired active gain of H_{E}(z):

g_{d}=1+gₐ(g₀−1)

Therefore:

$${g}_{a} = \frac{{g}_{d} - 1}{{g}_{0} - 1}$$

Derivation of Cut Case Gain gₐ

Assume bass shelf filter to simplify derivation. For bass shelf filters, the DC gain is the active region gain. Frequency analysis of H(z) is performed by making z=e^{jω}:

$$H ( ω ) = \frac{{b}_{0} + {b}_{1} {z}^{- j ω} + {b}_{2} {z}^{- j 2 ω}}{1 + {a}_{1} {z}^{- j ω} + {a}_{2} {z}^{- j 2 ω}}$$

The DC gain is now found by making ω equal to 0:

$$H ( 0 ) = \frac{{b}_{0} + {b}_{1} + {b}_{2}}{1 + {a}_{1} + {a}_{2}} = \frac{\sum B ( 0 )}{\sum A ( 0 )}$$

By definition, for bass shelf filters:

H_{E}(0)=g_{d} DC gain desired

H₀(0)=g₀ DC gain of original

For cut case filters:

$${H}_{E} ( z ) = \frac{{B}_{0} ( z )}{{B}_{0} ( z ) + {g}_{a} [ {A}_{0} ( z ) - {B}_{0} ( z ) ]}$$

$$\begin{matrix}{H}_{E} ( 0 ) = {g}_{d} = \frac{\sum {B}_{0} ( 0 )}{\sum [ {B}_{0} ( 0 ) + {g}_{a} ( {A}_{0} ( 0 ) - {B}_{0} ( 0 ) ) ]} \\ = \frac{\sum {B}_{0} ( 0 )}{\sum [ ( 1 - {g}_{a} ) {B}_{0} ( 0 ) + {g}_{a} {A}_{0} ( 0 )} \\ = \frac{\sum {B}_{0} ( 0 )}{\sum ( 1 - {g}_{a} ) {B}_{0} ( 0 ) + \sum {g}_{a} {A}_{0} ( 0 )}\end{matrix}$$

$${g}_{d} = \frac{\sum {B}_{0} ( 0 )}{( 1 - {g}_{a} ) \sum {B}_{0} ( 0 ) + {g}_{a} \sum {A}_{0} ( 0 )}$$

Therefore:

g_{d}{(1−gₐ)ΣB₀(0)+gₐΣA₀(0)}=ΣB₀(0)

$$\begin{matrix}\begin{matrix}\begin{matrix}\begin{matrix}\begin{matrix}\begin{matrix}\begin{matrix}\begin{matrix}{g}_{d} \{ \frac{( 1 - {g}_{a} ) \sum {B}_{0} ( 0 ) + {g}_{a} \sum {A}_{0} ( 0 )}{\sum {B}_{0} ( 0 )} \} = 1 \\ {g}_{d} \{ ( 1 - {g}_{a} ) + {g}_{a} \sum \frac{{A}_{0} ( 0 )}{\sum {B}_{0} ( 0 )} \} = 1\end{matrix} \\ But {H}_{0} ( 0 ) = {g}_{0} = \frac{\sum {B}_{0} ( 0 )}{\sum {A}_{0} ( 0 )}\end{matrix} \\ Therefore \text{:} {g}_{d} [ ( 1 - {g}_{a} ) + \frac{{g}_{a}}{{g}_{0}} ] = 1\end{matrix} \\ \frac{1}{{g}_{d}} = 1 - {g}_{a} + \frac{{g}_{a}}{{g}_{0}} \end{matrix} \\ \frac{{g}_{0}}{{g}_{d}} = {g}_{0} - {g}_{0} {g}_{a} + {g}_{a}\end{matrix} \\ \frac{{g}_{0}}{{g}_{d}} = {g}_{a} ( 1 - {g}_{0} ) + {g}_{0}\end{matrix} \\ {g}_{a} = \frac{\frac{{g}_{0}}{{g}_{d}} - {g}_{0}}{1 - {g}_{0}} = \frac{{g}_{0} - {g}_{d} {g}_{0}}{{g}_{d} ( 1 - {g}_{0} )}\end{matrix} \\ {g}_{a} = \frac{{g}_{0} - {g}_{d} {g}_{0}}{{g}_{d} - {g}_{d} {g}_{0}} or \frac{{g}_{0} - {g}_{0} {g}_{d}}{{g}_{d} - {g}_{0} {g}_{d}}\end{matrix}$$

Note: Although shown specifically for the bass shelf case, this gain also works for both treble shelf and bell-shaped (graphic equalizer) filters.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A method of designing a family of boost filters, each boost filter having a transfer function H(z) and a different selected gain g_{d}, comprising:
designing a first filter using conventional methods, the first filter having one of the selected gains g_{d} and denominator polynomial A₀(z) and numerator polynomial B₀(z);
decomposing the first filter into a circuit having an active region gain g₀ and two parallel branches, the first branch directly applying an input signal to a signal summer, the second branch applied to the signal summer and containing a series combination of a nominal filter having a transfer function Hₘ(z) and an amplifier having a gain gₐ; and
i) calculating gain gₐ for each said boost filter in the family, where
gₐ=(g_{d}−1)/(g₀−1)
ii) calculating the transfer function H(z) of each said boost filter, where
H(z)=[A₀(z)+gₐ(B₀(z)−A₀(z)]/A₀(z).

2. The method of claim 1 further comprising the step of designing a cut filter by replacing in the transfer function H(z) the coefficient A₀ for coefficient B₀, and replacing the coefficient B₀ with A₀, inversing the numerator and denominator of the transfer function H(z), and normalizing the transfer function H(z).

3. The method as specified in claim 2 wherein the normalizing is done by using a scalable inverse approximation technique.

4. The method as specified in claim 3 wherein the inverse approximation technique uses a table of 512 elements of 32 bits each.

5. A method of designing a family of cut filters, each cut filter having a transfer function H(z) and a different selected gain g_{d}, comprising:
designing a first filter using conventional methods, the first filter having one of the selected gains g_{d} and denominator polynomial A₀(z) and numerator polynomial B₀(z);
decomposing the first filter into a circuit having an active region gain g₀ and containing a series combination of a nominal filter having a transfer function Hₘ(z) and an amplifier having a gain gₐ; and
i) calculating gain gₐ for each said cut filter in the family, where
gₐ=(g₀−g₀g_{d})/(g_{d}−g₀g_{d})
ii) calculating the transfer function H(z) of each said cut filter, where
H(z)=B₀(z)/[B₀(z)+gₐ(A₀(z)−B₀(z)].

6. A method of designing a family of filters, each filter having a transfer function H(z) and a different selected gain g_{d}, comprising:
designing a first filter using conventional methods, the first filter having one of the selected gains and denominator polynomial A₀(z) and numerator polynomial B₀(z);
decomposing the first filter into a circuit having an active region gain g₀ and containing a series combination of a nominal filter having a transfer function Hₘ(z) and an amplifier having a gain gₐ; and
a) calculating gain gₐ for each filter in the family, where
(i) gₐ=(g_{d}−1)/(g₀−1) in the case of a boost filter family, and
(ii) gₐ=(g₀−g₀g_{d})/(g_{d}−g₀g_{d}) in the case of a cut filter family,
b) calculating the transfer function H(z) of each filter, where
(i) H(z)=[A₀(z)+gₐ(B₀(z)−A₀(z)]/A₀(z) in the case of a boost filter family, and
(ii) H(z)=B₀(z)/[B₀(z)+gₐ(A₀(z)−B₀(z)] in the case of a cut filter family.

7. The method as specified in claim 6 wherein the filters are bass shelf filters.

8. The method as specified in claim 6 wherein the filters are treble shelf filters.

9. The method as specified in claim 6 wherein the filters are graphic equalizer filters.

10. The method as specified in claim 6 wherein the filter gain changes are softened by changing the gain in linear fixed gain increments.

11. The method as specified in claim 6 wherein the filter gain changes are softened by moving through a fixed linear gain schedule.

12. An adjustable boost filter, comprising:
a first boost filter having a selectable gain g_{d} and derived from a standard filter having gain g_{d} and having denominator polynomial A₀(z) and numerator polynomial B₀(z);
the first boost filter being adapted to be decomposed into a circuit having an active region gain g₀ and two parallel branches, the first branch directly applying an input signal to a signal summer, the second branch being applied to the signal summer and containing a series combination of a nominal filter having a transfer function Hₘ(z) and an amplifier having a gain gₐ; and
a) wherein the first boost filter selectable gain g_{d} is defined by the equation:
gₐ=(g_{d}−1)/(g₀−1); and
b) wherein the first boost filter has a transfer function H(z), where:
H(z)=[A₀(z)+gₐ(B₀(z)−A₀(z)]/A₀(z).

13. The adjustable filter as specified in claim 12 wherein the boost filter is selected from the group comprising:
a bass shelf filter,
a treble shelf filter, and
a graphic equalizer filter.

14. An adjustable cut filter having a selectable gain g_{d} and derived from a standard filter having a transfer function
$$H ( z ) = \frac{{B}_{0}}{{A}_{0}} ,$$
said standard filter first being decomposed into a filter having an active gain g₀ and a loop gain gₐ, wherein:
a) the first cut filter selectable g_{d} is defined by the equation:
gₐ=(g₀−g₀g_{d})/(g_{d}−g₀g_{d}); and
b) the first cut filter has a transfer function H(z), where:
H(z)=B₀(z)/[B₀(z)+gₐ(A₀(z)−B₀(z)];
wherein:
A₀ is the denominator polynomial of standard filter; and
B₀ is the numerator polynomial of standard filter.

15. The adjustable filter as specified in claim 14 wherein the cut filter is an adjustable cut bass shelf filter.

16. The adjustable filter as specified in claim 14 wherein the cut filter is an adjustable cut treble shelf filter.

17. The adjustable filter as specified in claim 14 wherein the cut filter is an adjustable cut graphic equalizer filter.

18. The adjustable filter as specified in claim 14 wherein the cut filter is configured to be softened by linear fixed gain increments.

19. The adjustable filter as specified in claim 14 wherein the cut filter is configured to be softened by linear in linear gain increments.

20. A normalization filter having a transfer function H(z), comprising:
an input having a plurality of input branches summed by a signal summer, the input branches having coefficients of b₀, b₁, . . . bₙ; and
an output having a plurality of output branches from the signal summer, the output branches having coefficients 1/aₒ, a₁ . . . aₙ, whereby coefficient a₀ is the first coefficient of the denominator of the transfer function H(z).

21. The filter as specified in claim 20 further comprising delay functions z⁻¹ disposed between each of the input branches.

22. The filter as specified in claim 20 further comprising delay functions z⁻¹ disposed between each of the output branches.

23. The filter as specified in claim 20 wherein the normalization filter is adapted to normalize a filter having a transfer function
$$H ( z ) = \frac{Yo ( z )}{Xo ( z )} = \frac{{B}_{o} ( z )}{{A}_{o} ( z )}$$
where Bo(z) is equal to bₒ+b₁z⁻¹+ . . . bₙz⁻ⁿ and
Ao(z) is equal to aₒ+a₁z⁻¹+ . . . aₙz⁻ⁿ.

24. The filter as specified in claim 23 where n=2.

25. An adjustable filter derived from a standard filter, the adjustable filter having a transfer function H(z) and a selectable gain g_{d}, wherein the standard filter has one of the selected gains g_{d} and denominator polynomial A₀(z) and numerator polynomial B₀(z);
wherein the standard filter is decomposed into a circuit having an active region gain g₀ and two parallel branches, the first branch directly applying an input signal to a signal summer, the second branch applied to the signal summer and containing a series combination of a nominal filter having a transfer function Hₘ(z) and an amplifier having a gain gₐ; where:
a) gain gₐ for each filter is:
(i) gₐ=(g_{d}−1)/(g₀−1) in the case of a boost filter, and
(ii) gₐ=(g₀−g₀g_{d})/(g_{d}−gₒg_{d}) in the case of a cut filter,
b) where the transfer function H(z) of the adjustable filter is:
(i) H(z)=[A₀(z)+gₐ(B₀(z)−A₀(z)]/A₀(z) in the case of a boost filter, and
(ii) H(z)=B₀(z)/[B₀(z)+gₐ(A₀(z)−B₀(z)] in the case of a cut filter;
the adjustable filter further being coupled to a normalization filter having having a transfer function H_{T}(z), comprising:
an input having a plurality of input branches summed by a signal summer, the input branches having coefficients of bₒ, b₁, . . . bₙ; and
an output having a plurality of output branches from the signal summer, the output branches having coefficients 1/aₒ, a₁ . . . aₙ, whereby coefficient a₀ is the first coefficient of the numerator of the transfer function H_{T}(z).

26. The filter of claim 25 where the inverse of coefficient a₀ is formed by an approximation method.

27. The filter of claim 26 where gain changes of gain g_{d} are softened using small steps in linear gain.

28. The filter of claim 27 wherein the adjustable filter is adapted to implement treble boosts and cuts and adapted to provide treble control.

29. The filter of claim 27 wherein the adjustable filter is adapted to implement bass boosts and cuts and adapted to provide bass control.

30. The filter of claim 27 wherein the adjustable filter is adapted to implement bell-shaped boosts and cuts and adapted to provide a graphic equalizer.
